(19) United States
(12) Patent Application Publication
(10) Pub. No.: US 2013/0153722 A1
(43) Pub. Date: Jun. 20, 2013

(54) FURNITURE DRAWER SLIDE SPACER AND SHIPPING STRAP APPARATUS

(71) Applicant: Ryan Larkin, Fargo, ND (US)

(72) Inventor: Ryan Larkin, Fargo, ND (US)

(73) Assignee: SOLID COMFORT, INC., Fargo, ND (US)

(21) Appl. No.: 13/326,252

(22) Filed: Dec. 14, 2011

(51) Int. Cl. A47B 96/06; B23P 11/00

(52) U.S. Cl. 248/221.11; 29/525.11

(57) ABSTRACT

A universal spacer apparatus and method of use for securing a drawer slide of nearly any size into a furniture piece. The spacer apparatus comprises a rectangular block comprising a pair of placement pins, and a screw through hole in the apparatus's center. The placement pins snap into a pair of holes simultaneously drilled into the furniture panel, thus securing the spacer apparatus to the panel in a time efficient manner. The guide rail component of the drawer slide is then placed on the exposed face of the apparatus, and the rail is secured via inserting a screw through the rail and the apparatus, and into the furniture panel. The invention also comprises a method of securing drawers for transport to prevent damage comprising attaching straps to the back of the drawers, feeding the straps through a hole drilled into furniture's back panel, and affixing the straps to the panel.

### FIELD OF THE INVENTION

The present invention relates to an apparatus for affixing drawer sliders within furniture, and to a method of transporting the furniture without the drawers being dislodged and/or damaged.

### BACKGROUND

Drawer slides enable the movement of drawers within furniture, and are composed primarily of two components: the guide rail affixed to the furniture internal side panel, and the slider affixed to the drawer external side panel so that it moves back and forth within the guide rail. Drawer slide spacers are used to attach the guide rail to the furniture internal side wall, and thus it resides in the space between the two. The prior art discloses drawer slide spacers that are plastic and attached to the furniture side walls via screws or nails, which is a time consuming process. The spacers are also of various sizes to accommodate drawer boxes and drawer slides of various dimensions, so that the furniture assembler must select the appropriate spacer for each drawer type. Therefore, there is a need within the furniture industry to provide a universal spacer that can be used with a multitude of sizes of drawer slides, and that is quickly installed.

Once furniture drawers are installed and the furniture unit is ready for shipment, the drawers must be secured in a manner to prevent them from being dislodged and possibly damaged during transport. The standard in the furniture industry is to completely wrap the item in plastic sheeting, or other protective material. The prior art also discloses a variety of packaging apparatuses for shipping furniture that comprises laboriously covering the entire furniture piece. For example, U.S. patent application 20040232020 entitled “Packaging Assembly” discloses a flexible tube-like member that the furniture piece must be placed inside of. Likewise, U.S. Pat. No. 4,919,263 entitled “Container Packaging” discloses a complex apparatus with various components that requires extensive time and labor to implement so as to cover the entire furniture piece. Therefore, there is also a need within the furniture industry for an expedient method of securing drawers within furniture cabinets for shipment.

An object of the present invention is to eliminate problems, such as those described above, for example, and is directed to a universal spacer that can be used with a multitude of sizes of drawer slides, and that is quickly installed; and to an expedient method of securing drawers within furniture cabinets for shipment so that the drawers are not dislodged and/or damaged.

Further objects and advantages of the present invention are apparent from the following description of the invention.

### SUMMARY OF THE INVENTION

The present invention comprises a universal spacer apparatus to efficaciously affix the guide rail component of drawer slides to the inside walls of furniture, wherein the spacer apparatus will fit almost any size of guide rail. One each of the spacer apparatuses is placed on or near the ends of the guide rails in the space between the furniture internal side panel and the guide rails; such that four spacer apparatuses per drawer are required (e.g. there are two guide rails per drawer and two space apparatuses per guide rail).

The apparatus comprises a rectangular block comprising: two flat faces, two side faces, and two end faces. In a preferred embodiment of the present invention, the two flat faces are each about 2.225 inches in length (also known as height) and 0.74 inches in width; and the two end faces are each about 0.75 inches in depth and 0.74 inches in width; and the two side faces are each about 2.225 inches in length and 0.75 inches in width. It is noted, though, that the spacer apparatus may be in made within a range of side face widths to accommodate for different size side furniture panels and face frames, such as from about one quarter (0.25) inch to one (1) inch in one-sixteenth ( 1/16^{th}) inch increments.

One flat side of the spacer apparatus further comprises two placement pins molded to the block for use in snapping the block into two holes drilled into a furniture internal side panel, versus the prior art method of screwing in the spacer apparatuses. In a preferred embodiment, the placement pins are 0.125 inches in height, 0.2 inches (5 mm) in diameter, and are 1.266 inches (32 mm) apart (center hole-to-center hole). Placing the pins at this distance apart enables their use with Computer Numerically Controlled (CNC) woodworking equipment that will simultaneously drill two holes in the furniture internal side panel that are exactly 1.266 inches (32 mm) apart. Therefore, the furniture assembler saves time by not having to drill two holes sequentially, as well as by “snapping” the spacer apparatuses into place versus screwing them into the furniture internal side panel.

The spacer apparatus of the present invention is suitable for use with any size drawer slide (i.e. height/width and length variable) that requires the slide to be secured to the furniture internal side panels via a screw placed through the center line of the slide's guide rail (herein known as the “mounting hole”) and into the panel. The opposing flat side of the spacer apparatus (i.e. in relation to the pin placement flat side) is screwed or bolted in the middle to the guide rail wherein a screw is inserted through the rail's mounting hole, through the block's and into the furniture internal side panel. In a preferred embodiment of the present invention, the through hole for placing the screw (herein known as the “screw receiving hole”) is located in the center of the spacer apparatus flat face and possesses a diameter of about 0.094 inches.

The spacer apparatus may further comprise two countersunk, or conical holes, residing near the apparatus's flat face ends to further secure the spacer to the furniture internal side panel. A screw or bolt is inserted through the spacer apparatus, from the opposing flat side (i.e. guide rail facing side) to the pin placement flat side (i.e. furniture panel side) and into the furniture internal side panel. In a preferred embodiment of the present invention, the conical hole is about 42 degrees with a maximum diameter at the flat face surface of about 0.32 inches, and a conical depth of about 0.175 inches. And in the preferred embodiment, the through hole possesses a diameter of about 0.2 inches.

The present invention also comprises a method of use of the spacer apparatus of in mounting a guide rail component onto a furniture internal side panel, the method comprising the steps of: (a) selecting a drawer slide of an appropriate size to fit a drawer within a furniture cabinet, wherein said slide comprises a guide rail component and a slider component; and wherein said guide rail component comprises at least two mounting holes to secure said rail to said furniture panel; (b) drilling at least two pairs of vertically aligned holes into said furniture panel, wherein one hole within said pair lies above and one lies below said guide rail's mounting hole; (c) attaching one spacer apparatus over each of said panel's pairs of vertically aligned holes; (d) placing the guide rail component onto said spacer apparatuses such that the mounting hole within said guide rail component is aligned with the screw receiving hole in the center of each of said apparatuses; and, (e) threading a screw or bolt into said guide rail's mounting hole and then into said spacer apparatuses' receiving hole to secure the guide rail component to said panel. Additionally, these steps are included in the present inventions method of using a universal spacer apparatus to secure a drawer slide of nearly any size to a furniture internal side panel, the method comprising: steps (a) through (e) above, and then step (f) requires repeating steps (b) through (e) on the opposing furniture internal side panel one time; followed by step (g) securing a slider component to each of the drawer's two external side panels as per the drawer slide manufacturer's instruction; and, step (h) placing the sliders within said guide rail components and moving the drawer into said furniture cabinet by pushing said sliders through the length of said guide rails. It is noted, that in these methods, the step of attaching the spacer apparatuses to the furniture internal side panel comprises snapping a pair of pins protruding from each apparatus into the drilled holes within the furniture panel.

The present invention also comprises a method of use of four or more spacer apparatuses in affixing a drawer within a furniture cabinet an efficacious manner, wherein essentially two spacer apparatuses per guide rail are snapped into the furniture internal side panels and the two guide rails are secured to the said spacers and said panels. In a preferred embodiment of the present invention, the method comprises the following steps. In step one, the user selects a drawer slide of an appropriate size to fit a drawer within a piece of furniture, wherein said slide comprises a guide rail component and a slider component. In step two, the user marks on the two opposing furniture internal side panels the location of the guide rails' mounting holes. In step three, the user drills two pairs of holes into the furniture internal side panel, wherein each hole within a pair is vertically aligned in relationship to each other, and wherein one hole lies above and one below the mounting hole. In a preferred embodiment, each pair of holes is drilled simultaneously and at a distance of about 1.126 inches or 32 mm apart. In the fourth step, the user snaps the two placement pins protruding from each spacer apparatus's flat face into said pair of holes such that the apparatuses are mounted vertically on the furniture internal side panel. And optionally, the method further comprises inserting into each of two countersink holes located near the ends of the spacer apparatus's flat face, a screw or bolt to further secure the spacers to said panel.

In the fifth step for the method of use of the spacer apparatuses, the user places the guide rail onto the two spacer apparatuses such that the mounting hole within said guide rail is aligned with the screw receiving hole in the middle of each spacer apparatus. The guide rail should thus be mounted parallel to the floor. In the sixth step, the user threads a screw or bolt through the guide rail mounting hole, through the spacer apparatus's securing hole, and into the furniture internal side panel, thus securing the guide rail. In the seventh step, the user repeats step two through step seven of the present method resulting in a guide rail being mounted on opposing furniture internal side panels and aligned in parallel to each other and the drawer. In the eighth step, a drawer slide's slider component is mounted to each drawer's two external side panels as per the drawer slide manufacturer's direction, such as screwing or bolting, resulting in two sliders being affixed to each drawer. In the ninth step, the drawer is placed within the furniture by inserting said sliders into the guide rails on the opposing furniture internal side panels, and pushing the sliders and drawer through the length of the two guide rails.

The present invention further comprises an apparatus and method of transporting furniture comprising drawers, the method comprising: providing a packaging assembly comprising flexible strap-like members, wherein said members are affixed to the external surface of the back of said drawers; drilling holes within the back panel of said furniture, wherein said holes are aligned with the drawer; positioning the drawers within the furniture while threading the strap-like members through said holes to lie outside of the furniture; affixing said strap-like members to the external surface of the back of said furniture; transporting the packaged furniture; and, removing said strap-like members at the final location. The strap-like members may be affixed to the drawer in a loop configuration, or as a strip of material, wherein either must be of sufficient size to be securely grasped by an adult.

### BRIEF DESCRIPTION OF THE DRAWINGS

In the accompanying drawings, which illustrate an exemplary embodiment of the present invention:

FIG. 1A is an elevated perspective view of the spacer apparatus's furniture panel facing flat side.

FIG. 1B is an elevated perspective view of the spacer apparatus's guide rail facing flat side.

FIG. 1C is a side plain view of the spacer apparatus with dotted lines indicating holes and cavities within the apparatus.

FIG. 2 illustrates two of the spacer apparatuses affixing the drawer guide rail to the furniture internal side panel, and a slider residing within the guide rail.

FIG. 3 illustrates a drawer guide rail with sliders affixed to each opposing furniture internal side panel with the spacer apparatus and the holes within the furniture back panel for insertion of the strap-like members.

FIG. 4 illustrates the external surface of the furniture back panel with the strap-like members threaded through the holes.

### DETAILED DESCRIPTION

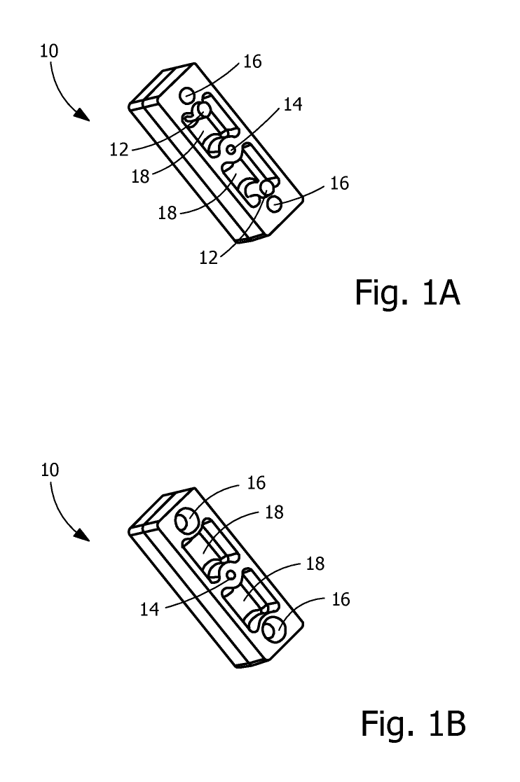

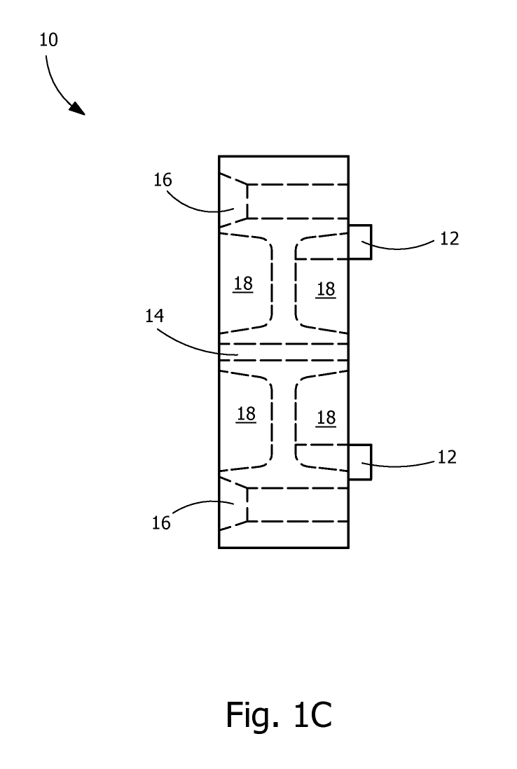

It is noted that although the following description details the use of two spacer apparatuses per guide rail, one of ordinary skill in the art could readily use the appropriate number of spacer apparatuses as designated by the guide rail structure. In an exemplary embodiment of the present invention, as illustrated in FIGS. 1A-C, the drawer slide spacers comprise a block shaped apparatus 10 comprising: two flat faces each about 2.25 inches in length and about 0.74 inches in width; two side faces each about 2.25 inches in length and about 0.75 inches in width; and two end faces each about 0.75 inches in height and about 0.74 inches in width. One flat side of spacer apparatus 10 is affixed to the furniture internal side panel (top, FIG. 1A) and the other flat side is affixed to the drawer guide rail (bottom, FIG. 1B). It is noted, though, that the width of the side faces may range from about one quarter (0.25) inch to about one inch in one-sixteenth ( 1/16^{th}) inch increments to accommodate for different size side furniture panels and face frames.

The spacer apparatus is affixed to the furniture internal side panel via means widely known in the art comprising a variety of mechanisms. In a preferred embodiment of the present invention as illustrated in FIGS. 1A & 1C, means of affixing the apparatus comprises snapping placement pins 12 molded to the block into holes drilled into the furniture internal side panels. Placement pins 12 are about 0.125 inches in height, 0.2 inches in diameter, and 1.266 inches (32 mm) apart (center hole-to-center hole), for use with Computer Numerically Controlled (CNC) woodworking equipment that will simultaneously drill two holes in the furniture internal side panel that are exactly 1.266 inches (32 mm) apart.

The guide rail component facing flat side may also comprise two countersink holes 16 near the ends of the block for further securing the spacer apparatus to the panel. In a preferred embodiment as illustrated in FIGS. 1A-1C, the countersink holes 16 lie tangent to the placement pins 12 along the center line of the block's lengthwise axis, and at a distance of about 0.24 inches from the ends of the block to the center of the holes 16, and wherein the holes are about 0.31 inches in maximum diameter. Additionally, in the preferred embodiment, the countersink holes have a sink hole depth of about 0.175 inches, and a through hole diameter of about 0.20 inches.

The spacer apparatus 10 further comprises a means for securing the guide rail to the furniture internal panel. In a preferred embodiment, as illustrated in FIGS. 1A-C, a “screw receiving” through hole 14 of about 0.0938 inches in diameter resides in the center of the spacer apparatus, wherein a screw is inserted through a hole within the guide rail center line, through the block hole 14, and into the furniture internal panel. Therefore, the spacer apparatus of the present invention is suitable for use with any size drawer slide (i.e. height and length variable) that require the slide be secured to the furniture internal panels via a screw placed through the center line of the guide rail and into the panel.

The spacer apparatus 10 may further comprise four cavities 18, as illustrated in FIGS. 1A-1C, resulting from the method of making the spacer apparatuses via injection molding. The cavities 18 reduce the overall weight and material requirements of the apparatus 10. In a preferred embodiment of the present invention, the cavities 18 are about 0.87 inches in length and 0.65 inches in width, and have a depth up to about 0.313 inches.

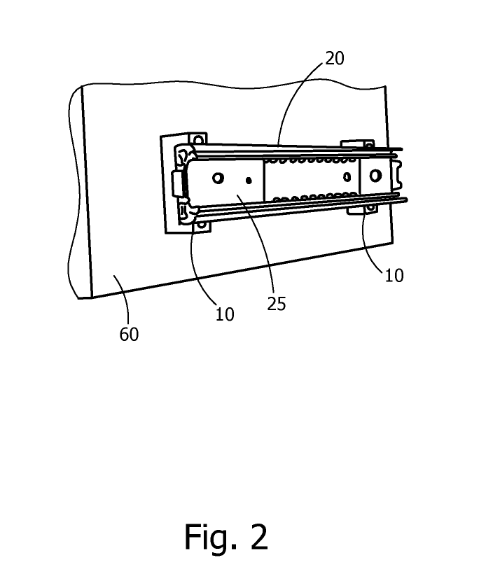

As illustrated in FIGS. 2 & 3, each drawer within a furniture piece requires at least two drawer slides, one mounted on each side panel of the drawer, wherein the slides comprise two components: a guide rail 20 affixed to the furniture internal side panel 60, and a slider 25 affixed to the drawer external side panel and moving along the length of the guide rail 20. (For clarity of viewing the illustration, the slider 25 is within the guide rail 20, and is not affixed to the drawer). Each drawer slider requires two spacer apparatuses 10 of the present invention mounted on opposing ends of each of two total guide rails 20 for a total of four apparatuses 10 per drawer. Although there are a variety of sizes of guide rails, such as 12, 13, or 14 inches, the spacer apparatuses of the present invention fit any size rail.

Method of Making Spacer Apparatuses:

The spacer apparatus 10 of the present invention is manufactured by methods well known in the art, such as via injection molding. Materials suitable for processing to produce the apparatuses 10 comprise primarily any injection moldable grade material. In a preferred embodiment of the present invention, the spacer apparatus 10 is made from polypropylene copolymer regrind material. Regrind materials include ground or chopped flash, runners, and non-contaminated rejected parts that are produced in-house by the molder in initial molding processes.

Method of Installing a Drawer Slide with the Spacer Apparatuses:

Means of affixing the guide rail 20 to the spacer apparatus 10 comprise the following steps. First a drawer slide of the appropriate size (i.e. length) to fit a drawer within a piece of furniture is selected. Methods of determining the appropriate size of drawer slide to use for a particular piece of furniture are widely known in the art. Drawer slides for use with the present invention comprise two main components: 1) a guide rail 20 component connected to the furniture internal side panel 60, and 2) a slider 25 connected to the drawer external side panel 60. Although the spacer apparatus 10 of the present invention will fit almost all standard drawer slides (i.e. 12, 13, 14 inch in length), the slides may not have a spacer already built into the slide such that the guide rail of the slide connects directly to the furniture internal side panel. The present invention is intended for drawer slides that require the user, or installer, to provide the spacer between the furniture internal side panel and the guide rail.

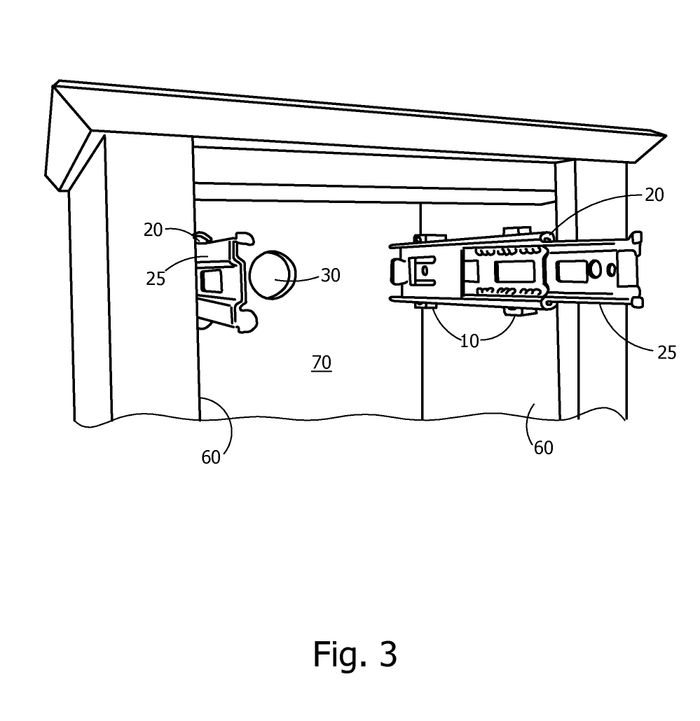

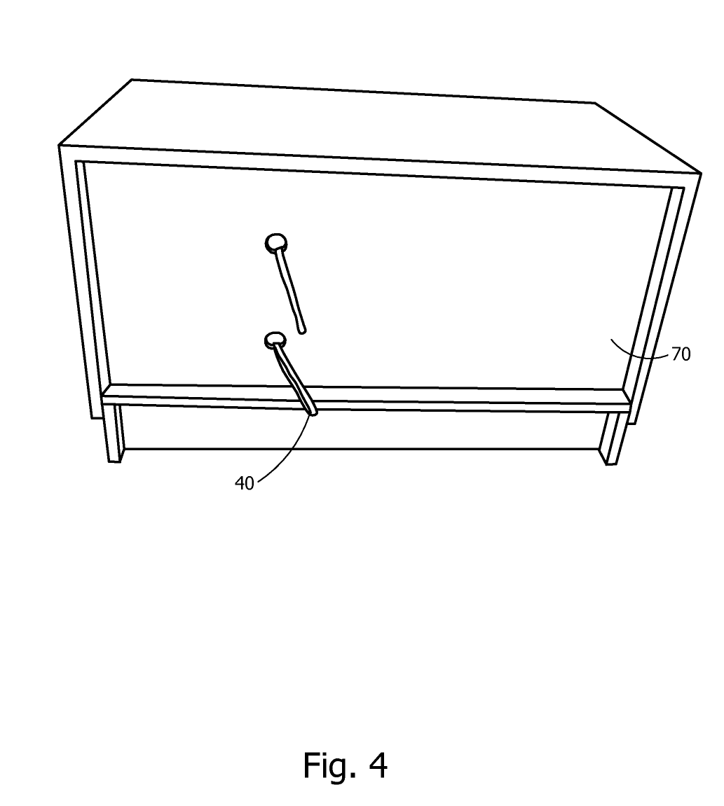

After the type and/or manufacturer of drawer slide is selected, the installer must optionally mark the furniture internal side panels for the location of the drawer slide's guide rail 20 and spacer apparatuses 10. Methods of marking may comprise simple techniques comprising a ruler and pencil, or more technically based techniques and equipment well known to furniture craftsmen. In particular, the installer must ensure the placement of the guide rails 20 on the furniture panels 60 properly aligns with the drawer and the drawer slider, and that the mounting hole of the guide rail is aligned with the screw receiving hole 14 of the spacer apparatus 10. The installer must also ensure that holes drilled for placement of the pair of pins 12 of the apparatus 10 are such that each hole within the pair is vertically aligned in relationship to each other and to the ground or furniture wall, and wherein one hole lies above and one below the guide rail's mounting hole at an equal distance. In most situations, one apparatus 10 is near the front end of the furniture and one apparatus 10 is near the back end of the furniture (see FIGS. 2 & 3) for a total of four apparatuses 10 per drawer (see FIG. 3).

The installer then affixes pairs of spacer apparatuses 10 to the furniture side panel 60 on each side of the drawer by drilling pairs of holes spaced the same distance as the placement pins 12, and then snapping the placement pins 12 into the holes. In a preferred embodiment, four pairs of holes are drilled 1.266 inches (32 mm) apart on opposing furniture internal side panels 60 such that each hole is 16 mm distance above or below the marking for the guide rail's mounting hole. The installer may use furniture drilling equipment and techniques well known in the art, such as the use of Computer Numerically Controlled (CNC) woodworking equipment that will simultaneously drill two holes to precise distances, thus significantly saving on installation time.

Once the holes are drilled into the furniture panel 60, the placement pins 12 of the apparatus 10 are fitted into the holes, thus mounting the apparatus vertically on the furniture panel 10. In a preferred embodiment of the present invention, the pins are structured to “snap” into the holes. While it is appreciated that one of ordinary skill in the art of furniture making would readily know of other pin structures, such as threads for screwing the pins into the wall, the snap abilities of the present invention decrease the required installation time and labor. It is also noted that the spacer apparatuses 10 in all embodiments of the present invention are mounted vertically onto the furniture internal side panel 60, such that flat face of the apparatus 10 is vertical to the ground.

At this point, the installer has the option of installing screws or bolts into the spacer apparatuses' two countersink holes 16 to further secure the spacer apparatuses 10 to the furniture internal side panels 60. As illustrated in FIGS. 1A-C, the bolts or screws are inserted near the ends of the spacer apparatuses 10, and into the holes 16, and inserted until the heads lie flush with said apparatuses flat face surfaces.

After the spacer apparatuses 10 are installed, then a guide rail 20 is placed on top of two horizontally aligned apparatuses 10 such that the two mounting holes within the rail (not shown in figures) are aligned with the receiving hole 14 in the middle of each apparatus 10. The guide rail 20 should thus be mounted parallel to the floor. Various means of attaching a guide rail to a spacer apparatus are well known in the art. In the exemplary embodiment of the present invention, the means comprises threading a screw or bolt from the drawer side of the guide rail 20, through the guide rail 20, and into the mid-section 14 of the apparatus 10 (see FIG. 1B & FIG. 2 right to left).

It is appreciated that each of the method steps of the present invention can be sequentially followed in installing each guide rail and then repeated for the opposing guide rail of a drawer, or the steps may be duplicated to mount pairs of guide rails concurrently. Once the guide rails 20 are affixed to the furniture internal side panel 60 via the spacer apparatus 10, then a slider 25 is mounted onto the two drawer's external side walls. It is noted that for ease of illustrating the apparatus of the present invention, the slider 25 is illustrated attached to the guide rail 20 and in the absence of the drawer. The slider 25 is mounted to the drawer external side panels as per each manufacturer's direction, such as by installing screws or bolts, and then the drawer is placed within the furniture by inserting the sliders 25 on each drawer side into the guide rails 20 and pushing the sliders 25 through the length of the rails 20.

### Drawer Shipping Straps

As further illustrated in FIGS. 3 & 4, the present invention comprises a means of securing drawers within furniture for transporting the furniture such that the drawers will not be dislodged and/or damaged. In a preferred embodiment of the present invention, the means comprises drilling a hole 30 within the furniture back panel 70, wherein a strap-like member 40 that is attached to the drawer back panel (not shown) is threaded through the hole 30 and affixed to the external surface of the furniture back panel. Means of affixing the strap-like member 40 to a furniture panel are well known in the art, such as stapling or taping. The holes 30 are of about 1.40 inches (35 millimeters) in diameter, and they are aligned with the drawer back panel.

As illustrated in FIG. 4, the strap-like member 40 comprises a strip of leather, cloth, or other flexible material configured into a loop configuration of sufficient length to be grasped by an adult sized hand. The member 40 is secured to the drawer back panel and to the external surface of the furniture back panel 70 by means widely known in the carpentry industry. In the preferred embodiment of the present invention, the strap-like member 40 is a strip of fabric or nylon, such as 0.5 inch width, folded in half once and stapled at the free ends to form a closed loop extending from the external surface of the drawer back panel. The drawers are then placed within the furniture while threading the strap-like members 40 through the holes 30, and then affixing the members 40 to the external surface of the back of said furniture via, for example, stapling. After the furniture is transported and setup, the strap-like members 40 are then removed from the furniture back panel 70 and the drawer external back panel by cutting the straps 40.

Various modifications and additions can be made to the embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A universal spacer apparatus for securing the guide rail component of nearly any size drawer slide to a furniture internal side panel, said apparatus comprising:
a) a rectangular block comprising, two flat faces, two side faces, and two end faces, wherein said flat faces comprise a furniture panel contact face and a guide rail component contact face;
b) two placement pins protruding from said block's furniture panel contact face; wherein said pins reside a fixed distance apart on the center line of said face's lengthwise axis, and wherein said pins secure said block to said panel face; and,
c) a screw receiving through hole in the center of said block for securing said guide rail component to said block and to said furniture internal side panel.

2. The spacer apparatus of claim 1, wherein said screw receiving hole lies halfway between said two placement pins along said face's lengthwise axis.

3. The spacer apparatus of claim 1, wherein said placement pins are shaped to snap into holes drilled into said furniture internal side panel.

4. The spacer apparatus of claim 1, further comprising two countersink holes lying tangent to said placement pins along the center line of said block's lengthwise axis, and wherein said countersink holes further secure said block to said furniture internal side panel.

5. The spacer apparatus of claim 1, further comprising two approximately rectangular shaped cavities per said block's flat side, wherein the depth of each cavity is less than about half the width of said block's side face.

6. The spacer apparatus of claim 1, wherein said placement pins are spaced about 1.266 inches apart, are about 0.125 inches in height, and are shaped to snap into a pair of vertical holes simultaneously drilled into said furniture internal side panel.

7. The spacer apparatus of claim 1, wherein said block's side faces are from about one quarter inch to about one inch in width.

8. The spacer apparatus of claim 1, wherein said two flat faces are each about 2.25 inches in length and about 0.74 inches in width; said two side faces are each about 2.25 inches in length and about 0.75 inches in width; and said two end faces are each about 0.75 inches in height and about 0.74 inches in width.

9. A method of use of the spacer apparatus of claim 1 in mounting a guide rail component onto a furniture internal side panel, the method comprising:
a) selecting a drawer slide of an appropriate size to fit a drawer within a furniture cabinet, wherein said slide comprises a guide rail component and a slider component; and wherein said guide rail component comprises at least two mounting holes to secure said rail to said furniture panel;
b) drilling at least two pairs of vertically aligned holes into said furniture panel, wherein one hole within said pair lies above and one lies below said guide rail's mounting hole;
c) attaching one spacer apparatus over each of said panel's pairs of vertically aligned holes;
d) placing the guide rail component onto said spacer apparatuses such that the mounting hole within said guide rail component is aligned with the screw receiving hole in the center of each of said apparatuses; and,
e) threading a screw or bolt into said guide rail's mounting hole and then into said spacer apparatuses' receiving hole to secure the guide rail component to said panel.

10. The method of claim 9, wherein said attaching of spacer apparatuses comprises snapping a pair of pins protruding from each apparatus into said drilled holes within said furniture panel.

11. The method of claim 9, wherein said drilling of two pairs of vertical aligned holes comprises drilling a distance of about 1.126 inches between the two holes within a pair of holes.

12. The method of claim 11, wherein said drilling comprises using Computer Numerically Controlled (CNC) woodworking equipment to simultaneously drill said two holes within a pair of holes.

13. A method of using a universal spacer apparatus to secure a drawer slide of nearly any size to a furniture internal side panel, the method comprising:
a) selecting a drawer slide of an appropriate size to fit a drawer within a furniture cabinet, wherein said slide comprises a guide rail component and a slider component; and wherein said guide rail component comprises at least two mounting holes to secure said rail to said furniture panel;
b) drilling at least two pairs of vertically aligned holes into said furniture panel, wherein one hole within said pair lies above and one lies below said guide rail's mounting hole;
c) attaching one spacer apparatus over each of said panel's pairs of vertically aligned holes;
d) placing the guide rail component onto said spacer apparatuses such that the mounting hole within said guide rail component is aligned with the screw receiving hole in the center of each of said apparatuses;
e) threading a screw or bolt into said guide rail's mounting hole and then into said spacer apparatuses' receiving hole to secure the guide rail component to said panel;
f) repeating steps (b) through (e) on the opposing furniture internal side panel one time;
g) securing a slider component to each of the drawer's two external side panels as per the drawer slide manufacturer's instruction; and,
h) placing the sliders within said guide rail components and moving the drawer into said furniture cabinet by pushing said sliders through the length of said guide rails.

14. The method of claim 13, wherein said universal spacer apparatuses each comprise, a rectangular block comprising, two flat faces, two side faces, and two end faces, wherein said flat faces comprise a furniture panel contact face with said two placement pins and a guide rail component contact face with said screw receiving through hole.

15. The method of claim 13, wherein said drilling of two pairs of vertical aligned holes comprises drilling a distance of about 1.126 inches between the two holes within a pair of holes, and wherein said placement pins are about 1.126 inches apart on said apparatus's center axis.

16. The method of claim 15, wherein said drilling comprises using Computer Numerically Controlled (CNC) woodworking equipment to simultaneously drill said two holes within a pair of holes.

17. The method of claim 13, wherein said attaching of spacer apparatuses comprises snapping a pair of pins protruding from each apparatus into said drilled holes within said furniture panel.

18. A method of securing drawers within furniture to prevent dislodgement of said drawers during transport, the method comprising:
a) providing a packaging assembly comprising flexible strap-like members;
b) affixing said members to the external surface of the back of said drawers;
c) drilling holes within the back panel of said furniture, wherein said holes are aligned with the drawer;
d) positioning the drawers within the furniture while threading the strap-like members through said holes;
e) affixing said strap-like members to the external surface of the back of said furniture;
f) transporting the packaged furniture; and,
g) removing said strap-like member from said furniture and said drawer.

19. The method of claim 18, wherein said strap-like members are affixed to the external surface of the back of said drawers in a loop configuration of sufficient size to be grasped.

20. The method of claim 18, wherein said strap-like members comprise nylon material.
